(19) United States
(12) Patent Application Publication
(10) Pub. No.: US 2019/0011324 A1
(43) Pub. Date: Jan. 10, 2019

(54) A Method of Assessing the Condition of a Tubular Member

(71) Applicant: Flexlife Limited, Aberdeenshire (GB)

(72) Inventor: Craig Nelson, Montrose Angus (GB)

(73) Assignee: Flexlife Limited, Aberdeenshire (GB)

(21) Appl. No.: 15/752,453

(22) PCT Filed: Aug. 17, 2016
(86) PCT No.: PCT/GB2016/052543

§ 371 Date: Feb. 13, 2018

(30) Foreign Application Priority Data
Aug. 17, 2015 (GB) 1514578.2

(51) Int. Cl. G01M 3/22

(52) U.S. Cl. CPC G01M 3/222

(57) ABSTRACT

In a method of assessing the condition of a tubular member, for example a flexible riser, an inert fluid is flowed from a fluid source through a conduit connected to a laminar flow device, which can determine volumetric and/or mass flow rate of the fluid. The fluid is flowed through the laminar flow device into the riser annulus, and flow continues until the fluid pressure within the annulus stabilises. The volume of fluid flowed into the annulus offers an indication of the integrity of the riser, for example, whether any fluid is present therein.

The present invention relates to an inspection method and apparatus and more specifically relates to a method and apparatus for inspecting tubular member annuli and more particularly flexible pipeline annuli, using mass flow technology.

### BACKGROUND OF THE INVENTION

Pipes are generally described as rigid or flexible. Flexible pipes are generally multi-layered, unbonded and formed from materials that permit the pipe to flex and bend relatively easily, and are typically constructed of layers of materials such as polymers and metals or composites. Their flexibility makes them more able to withstand cyclic bending motions, and they are therefore more resistant to fatigue than rigid risers, while maintaining ease of installation, so they are used throughout the oil and gas industry for both on and (predominantly) offshore deployment.

FIGS. 1 and 2 show part cross-sections through two flexible pipe constructions which are useful for understanding the present invention.

The flexible pipe of FIG. 1 is a rough bore flexible pipe, which comprises an inner carcass 1 generally formed of interlocked wires, which provides stability to the pipeline and resists collapse of the construction. Surrounding the carcass is an inner pressure sheath 2, which is generally formed by a thermoplastic inner fluid barrier and provides a seal to prevent internal fluid flowing in the pipeline from escaping from the inner carcass. A pressure armour 3 is formed around the outer surface of the pressure sheath and provides hoop strength to the pipeline to prevent collapse and/or prevent burst. A helically wound tensile armour 4 formed of rectangular or round wire or composite rods is provided over the pressure armour to provide axial support and to resist hoop strain. A wear layer 5 of thermoplastic or tape overlies the tensile armour 4 and limits the steel layer wear by reducing the contact forces and abrasion thereon. The wear layer 5 also constrains the wires and acts as a manufacturing aid.

In the example shown, a further tensile armour 4′ is applied over the wear layer 5 and followed by a thermal insulation layer 6 which reduces heat loss from the pipeline. An outer sheath 7 of between 3 and 30 mm thickness surrounds the inner layers, said outer sheath being formed of a thermoplastic, which provides environmental protection and prevents seawater ingress into the pipeline.

FIG. 2 shows a typical construction for a smoothbore flexible pipe which is formed of an inner liner 8 of thermoplastics, which provides an inner fluid barrier without the requirement for an internal carcass, surrounded by a pressure armour 3 as described in relation to FIG. 1. Surrounding the pressure armour 3 is an intermediate seal 9, which is formed from a thermoplastic hydrostatic pressure barrier, which allows the pressure armour 3 to resist hydrostatic load when the outer sheath 7 is breached as discussed further below.

A tensile armour 4 surrounds the intermediate seal over which a wear layer 5 and further tensile armour 4′ are provided. Finally the outer sheath 7 surrounds the preceding layers as described above.

In some cases, a further thermoplastic extrusion (not shown) may be provided over the outer sheath 7 to protect the outer sheath 7 from loads and abrasion and an external carcass (not shown) may surround the entire pipeline to protect the sheath 7 from loads, abrasion and impact damage, particularly where the pipeline is laid on the sea bed. Flexible pipes are usually constructed using the layers listed above but can comprise multiples of these layers, or can comprise different layers depending on the application.

The annulus of the pipe, the pressure armour 3 and tensile armour 4, 4′ layers are of particular interest in relation to the present invention. The annulus is the space between the outer sheath 7 and an internal sealing layer such as the internal pressure sheath 2, 3, liner 8, or intermediate seal 9. The tensile and pressure armour layers are the outer wires, which withstand as their name suggests the tensile loads and pressure induced loads of the pipe and are located within the annulus. The fatigue resistance of a flexible pipe is significantly reduced when the tensile armour 4, 4′ or pressure armour 3 wires of a pipe are exposed to seawater, corroded, or damaged.

The integrity of pipelines is of critical importance in the oil and gas industry, as any loss of integrity could lead to catastrophic failure of the structure, resulting in significant damage to both the environment and the businesses involved. The condition of the flexible pipe annulus becomes more critical to the service life and performance of the pipe the more dynamic the pipe is. Thus, risers and dynamic jumpers are more sensitive to fatigue than, for example, flowlines and static jumpers.

The annulus can be flooded with seawater through ingress via the splash zone or through a breach in the pipe below sea level, or can be flooded with fluid permeating from the bore, for example, condensation. Sea water in the annulus reduces the service life of the pipe. Monitoring the condition of the annulus using, for example, the height of fluid in the annulus, or the ratio of flooded to non-flooded portions of the pipe, is important for predicting the remnant life of the pipe and assessment of flexible pipe assets offshore. Flooding can occur throughout the entire pipeline or in localised regions along the pipeline. Flooding in localised regions could be either condensate or sea water so the level of fluid or remnant free volume is usefully trended over time to identify the fluid; this is important to any conclusions derived as to the status of the outer sheath integrity.

Generally the volume of the annulus is known within acceptable tolerances. Testing the free volume of the annulus and comparing this value to the known volume can provide valuable information on the level of any fluid within the annulus. A lower free volume than expected suggests fluid is accumulating within the annulus and is depressing the free volume; the level of this fluid can usefully be measured and monitored to determine the type of fluid and whether it is of concern. For example, if the measured free volume is similar to the calculated volume between the top of the annulus and the measured sea level, this can indicate a potential subsea breach of the outer sheath, and/or end termination failure, through which sea water is entering the annulus. This is a highly damaging occurrence, for which the recommended intervention, after analysis, could result in a complete well shut down, and recovery and replacement of the entire riser system. However if the fluid level as measured and trended over a period of time is below sea level, this generally indicates accumulation of condensate, for which the recommended intervention is often less severe, and in this case replacement of the riser may not be necessary. It is desirable that these two conditions are correctly distinguished to ensure that the correct intervention path is chosen, so that damage is avoided, but at the same time riser systems are not being needlessly replaced.

Currently testing is commonly carried out using vacuum testing which carries a risk of raising the level of any fluid contained therein and flooding the annulus, particularly if the free volume is very small. Another major risk while conducting vacuum testing is vent blockage. Within the topside end termination of a flexible riser there are normally multiple vent ports which are usually the only means of communication from the riser annulus to the outside environment. The vent ports are important for the safe operation of the riser structure. The vent ports are normally connected to the internal annulus of the riser via small-bore tubing. During the riser's life the small-bore vent ports often become blocked as debris within the annulus is drawn under vacuum through the small-bore tubing, where it tends to compact and block the vent. This can lead to a build-up of permeated gas within the annulus and ultimately to outer sheath failure. Usually this will occur within an area of the pipe unsupported by hydrostatic pressure, i.e. in the splash zone section of pipe in air or shallow water.

An alternative method of measuring the free volume of the annulus is by using positive pressure. In this case, a gas, for example nitrogen, is used to flood the annulus until the gas pressure stabilises. The starting gas pressure of both the supply and annulus will have been measured at the beginning of the flooding process. Using Boyle's law, P₁V₁=P₂V₂, the free volume can be calculated by a measurement of supply gas used to achieve a pressure increase within the annulus, typically 3 barg target annular pressure. However, this method incurs significant inaccuracies at many different stages, either through human or systematic errors. The dimensions of the pipelines change during use due to operational pressures and temperatures, and can result in a larger volume within the annulus than expected, with the effects felt more on a longer pipeline than a short one. The annular temperature can differ from riser to riser, affecting the density/pressure reading of the bottled gas testing medium at an ambient temperature and the resulting annular pressure reading. The temperature of the gas from the supply bottle and supply lines could, in certain cases, be different to the temperature of the same gas when it is injected into, and stabilises within, the annulus. A warm supply of gas will become more dense in a cooler annulus, and a cool supply of gas will become less dense within a warm annulus. In both scenarios, using this alternative, positive pressure based method results in the measured gas consumption values becoming very difficult to track, calculate and report on, as the appropriate gauges for this method (for example Keller LEO Record gauges) only measure pressure drop and ambient temperature, with no capacity to quantify temperature effect. The temperature of the gas within the supply bottle, supply lines, and annulus all influence the final measured volume, leading to significant inaccuracies. Back pressure from the annulus can restrict the flow of the testing medium into the annulus, thereby affecting the gauge readings; and the starting pressure data (particularly from the supply) can be highly inaccurate depending on when the reading is taken and which valves are open or closed at the time of recordal. These inaccuracies lead to the testing data being more qualitative than desired given the potential impact of an incorrect assessment of a subsea breach.

### SUMMARY OF THE INVENTION

In accordance with a first aspect of the invention, there is provided a method of assessing the condition of a tubular member, the method comprising flowing a fluid into the tubular member through a laminar flow device.

Optionally the volumetric flow rate of the fluid flowing into the tubular member is determined by the laminar flow device. Optionally the mass flow rate of the fluid flowing into the tubular member is determined by the laminar flow device. Optionally the volumetric flow rate and/or the mass flow rate is determined by calculation from measured values determined by the laminar flow device. Optionally the laminar flow device comprises a pressure sensor. Optionally the laminar flow device has a laminar flow path through the device, with a pressure sensor at each end of the laminar flow path, and the pressure drop over the laminar flow path is optionally measured to determine the mass or volumetric flow rate by calculation. Optionally the laminar flow device is a mass flow meter, adapted to calculate mass flow rate.

One example of a suitable laminar flow device is the M-Series mass flow meter available from Alicat Scientific. U.S. Pat. No. 4,118,973, U.S. Pat. No. 5,511,416, and U.S. Pat. No. 5,297,427 are useful for understanding some examples of laminar flow devices, and are incorporated herein by reference.

Optionally the tubular member comprises a flexible pipe such as a riser, adapted to provide a conduit through the water column between a subsea facility such as a wellhead or pipeline, and a surface facility such as a drilling or production platform or vessel, and is optionally adapted for use with an offshore oil and gas well.

Optionally the flexible pipe has a number of layers and an annulus between an outer layer and an inner layer. Optionally the outer and inner layers are adapted to seal the annulus.

Optionally the fluid is flowed into the annulus.

Optionally the volume of fluid flowing into the tubular can be used to determine information concerning the integrity of the outer sheath of the riser when analysed in conjunction with an annular pressure increase resulting from the flow of fluid into the annulus. Optionally the mass of fluid flowing into the tubular can be used to determine the same information.

Optionally the tubular member comprises at least one port (optionally 2 or 3 or more ports) allowing access to the annulus from outside the outer layer of the tubular member. Optionally the method permits inspection of the integrity of the tubular member, particularly of the condition of the annulus, outer sheath, and particularly allows the determination of the free volume of the annulus by comparison of the calculated total volume or optionally mass of gas injected with earlier readings of the same, optionally in conjunction with theoretical free volume measurements, in order to establish comparative changes in volume or mass flowing into the annulus.

Optionally the mass flow rate of the fluid into the tubular member is calculated, and used to determine the volume of fluid passing into the tubular member, and hence permits determination of the remnant volume of the annulus. The fluid is flowed through a laminar flow device, optionally a mass flow meter, into the tubular member, optionally into the annulus. Optionally the laminar flow device is connected in a fluid conduit between a source of the fluid, which is optionally pressurised, and the tubular member. Optionally the laminar flow device is connected in an exhaust conduit and optionally calculates the volume of gas vented from the annulus at the end of the testing process. Optionally a laminar flow device is placed on both the inlet and exhaust conduits to calculate the volumes of the injected fluid and the exhausted fluid, optionally for cross-checking of the two values. Optionally the mass of injected and exhausted fluid is calculated.

Optionally the method includes controlling the flow rate of the fluid into the laminar flow device. Optionally the fluid can be flowed through a flow rate limiting device prior to the fluid passing through the laminar flow device.

Optionally the method includes recording the volume of fluid injected into the tubular member by measuring the volumetric flow rate of the fluid through the laminar flow device. Optionally the mass of fluid is measured and the volume of fluid injected is calculated from this measurement.

Optionally the fluid is a gas when flowed into the tubular member, and is optionally an inert gas such as gaseous nitrogen.

Optionally the temperature of the fluid is measured by at least one sensor. Optionally the pressure of the fluid is measured by at least one sensor. Optionally the sensors measure the temperature and/or pressure within the supply vessel for the fluid, which is optionally pressurised. Optionally the sensors measure the temperature and pressure of the fluid at a different location in a fluid conduit delivering the fluid to the tubular member. Optionally the sensors measure the temperature and pressure of the test medium at more than one location in the fluid conduit. Optionally the temperature and pressure of the fluid are measured by the laminar flow device.

Optionally the temperature is measured by at least one sensor, optionally the laminar flow device, as the fluid is being flowed into the tubular member. Optionally the temperature is measured by at least one sensor, optionally the laminar flow device, as the fluid is being exhausted. Optionally the temperature data is continuously recorded during the integrity assessment operation. Optionally the recorded temperature data can be used to adjust the values for other readings such as the pressure of the fluid. The recording and analysis of temperature data offers the advantage of being able to perform a final-value correction that accounts for changes in temperature of the fluid between the fluid source, which may be at one temperature, and the annulus, which may be at a significantly different temperature.

Optionally the flow rate limiting device comprises a fluid flow governor such as a rotameter. Typically the flow rate of the fluid is constrained within a range of 10-80 litres per minute, optionally within a range of 20-70 litres per minute, optionally within a range of 20-50 litres per minute. Different rates can apply in different examples.

Optionally the flow rate limiting device is adapted to sense back pressure, optionally within the annulus or in the conduit extending from the laminar flow device into the annulus. Optionally the flow rate limiting device can be used to indicate or optionally measure clearing of restrictions or blockages in the tubular member, for example a blocked port in the riser annulus.

Optionally the pressurisation of the riser annulus is constrained to a value equal to or less than 3 bars/300 kPa. Different pressures can apply in different examples.

Optionally the fluid is passively vented from the tubular member. Optionally the fluid is actively vented, for example, under an applied pressure differential. Optionally as the fluid is vented from the tubular member, the volume of the exhausted fluid is measured for comparison to the volume injected into the tubular member.

In accordance with a second aspect of the invention, there is provided apparatus for assessing the condition of a tubular member, the apparatus comprising a fluid conduit to supply fluid from a fluid source to the tubular member and a laminar flow device connected with the fluid conduit whereby fluid flows through the laminar flow device prior to flowing into the tubular member.

Optionally the laminar flow device is configured to determine the total volume of the fluid as it flows into the tubular member.

Optionally the laminar flow device is adapted to determine the mass of the fluid as it flows into the tubular member.

The various aspects of the present invention can be practiced alone or in combination with one or more of the other aspects, as will be appreciated by those skilled in the relevant arts. The various aspects of the invention can optionally be provided in combination with one or more of the optional features of the other aspects of the invention. Also, optional features described in relation to one aspect can typically be combined alone or together with other features in different aspects of the invention. Any subject matter described in this specification can be combined with any other subject matter in the specification to form a novel combination.

Various aspects of the invention will now be described in detail with reference to the accompanying figures. Still other aspects, features, and advantages of the present invention are readily apparent from the entire description thereof, including the figures, which illustrates a number of exemplary aspects and implementations. The invention is also capable of other and different examples and aspects, and its several details can be modified in various respects, all without departing from the spirit and scope of the present invention. Accordingly, the drawings and descriptions are to be regarded as illustrative in nature, and not as restrictive. Furthermore, the terminology and phraseology used herein is solely used for descriptive purposes and should not be construed as limiting in scope. Language such as “including”, “comprising”, “having”, “containing”, or “involving” and variations thereof, is intended to be broad and encompass the subject matter listed thereafter, equivalents, and additional subject matter not recited, and is not intended to exclude other additives, components, integers or steps. Likewise, the term “comprising” is considered synonymous with the terms “including” or “containing” for applicable legal purposes. Thus, throughout the specification and claims unless the context requires otherwise, the word “comprise” or variations thereof such as “comprises” or “comprising” will be understood to imply the inclusion of a stated integer or group of integers but not the exclusion of any other integer or group of integers.

Any discussion of documents, acts, materials, devices, articles and the like is included in the specification solely for the purpose of providing a context for the present invention. It is not suggested or represented that any or all of these matters formed part of the prior art base or were common general knowledge in the field relevant to the present invention.

In this disclosure, whenever a composition, an element or a group of elements is preceded with the transitional phrase “comprising”, it is understood that we also contemplate the same composition, element or group of elements with transitional phrases “consisting essentially of”, “consisting”, “selected from the group of consisting of”, “including”, or “is” preceding the recitation of the composition, element or group of elements and vice versa. In this disclosure, the words “typically” or “optionally” are to be understood as being intended to indicate optional or non-essential features of the invention which are present in certain examples but which can be omitted in others without departing from the scope of the invention.

All numerical values in this disclosure are understood as being modified by “about”. All singular forms of elements, or any other components described herein are understood to include plural forms thereof and vice versa. References to directional and positional descriptions such as upper and lower and directions e.g. “up”, “down” etc. are to be interpreted by a skilled reader in the context of the examples described to refer to the orientation of features shown in the drawings, and are not to be interpreted as limiting the invention to the literal interpretation of the term, but instead should be as understood by the skilled addressee.

### BRIEF DESCRIPTION OF THE DRAWINGS

In the accompanying drawings:

FIG. 1 shows a generic subsea riser which does not embody the invention, and which is illustrated to provide context for understanding the later examples of the invention described in this application;

FIG. 2 shows a second generic subsea riser, which does not embody the invention, and which is also illustrated for context, to allow a better understanding of the invention;

FIG. 3 shows a schematic representation of one example of apparatus for assessing the condition of an annulus in a subsea riser with three different fluid levels indicated within the annulus.

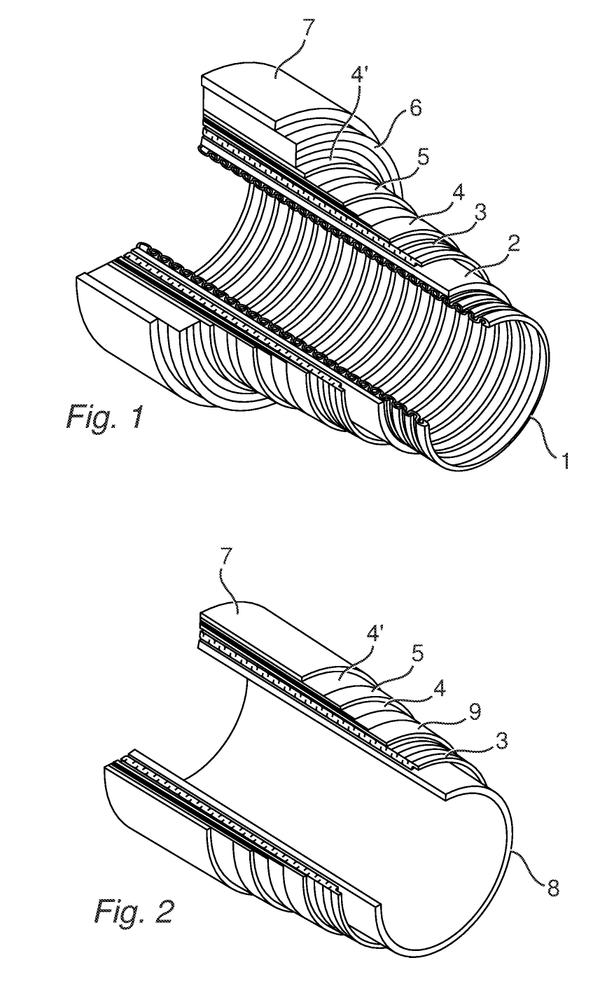

### DETAILED DESCRIPTION OF THE INVENTION

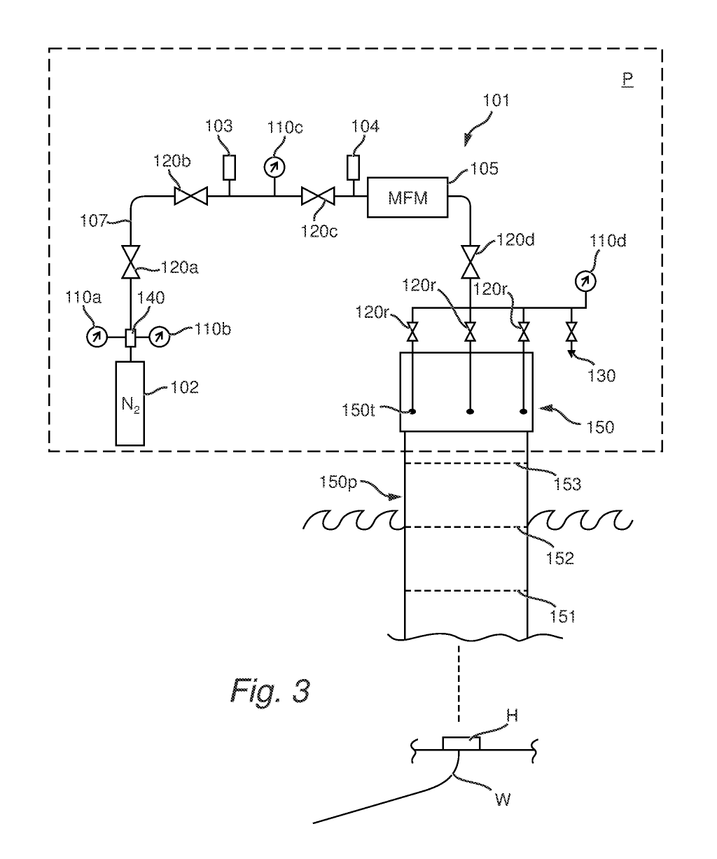

Referring to FIG. 3, this drawing shows a schematic of one example of apparatus suitable for assessing the condition of a tubular member in the form of a subsea riser 150 connected between a subsea wellhead H of an oil or gas well W and a platform P such as a drilling or production platform on which the apparatus is optionally mounted. The riser 150 provides a conduit between the platform P and the wellhead H to allow fluids from the well W to flow to the platform for export to a pipeline (not shown). Production fluids from the well typically flow in pipes and tubes such as production tubing housed within the riser 150. The apparatus described in this example comprises an annulus testing kit 101, connected to the annulus of the riser 150 via the internal vent system to external vent port The test kit 101 allows the flow of fluid into the annulus of the riser 150 for assessment of the condition of the annulus, namely, the remnant free volume in the annulus. For this purpose a test fluid is flowed into the annulus of the riser 150 to determine the remnant free volume. The components of the test kit 101 are illustrated schematically in order to illustrate one example of how the invention might be practiced, and other arrangements of components could be used.

The test kit 101 comprises a source of test fluid for flowing into the riser comprising a cylinder 102 which is optionally pressurised, and in this example is filled with pressurised inert nitrogen gas. The fluid flows through a gas line 107 between the source cylinder 102 and the annulus of the riser passing through various control valves 120a-d, a pressure relief valve 103, regulator 140, optional flow rate governor 104, and gauges 110a-d before flowing from the gas line 107 into a number of annulus ports which are in fluid communication with the annulus of the riser 150, and are generally disposed on the end termination of the riser, which is often on the platform, or is accessible from the platform. It should be noted that other examples of the invention are envisaged without any connection to a platform. The valves, regulators, governors and gauges etc. control the flow of the fluid into the annulus from the source cylinder 102, via the gas line 107. The fluid flowing into the annulus from the source cylinder 102 through the gas line 107 also passes through a laminar flow device 105, which determines the volume and/or mass of fluid flowing into the annulus. In this example, a laminar flow device in the form of a mass flow meter directly measures the volumetric flow rate passing through the mass flow meter 105 and in conjunction with a totaliser function integrated into the device, calculates the total volume and mass of the fluid flowed into the annulus.

Laminar flow provides significant improvements in accuracy due to the tight restriction of the fluid into extremely narrow fluid flow channelling elements. The elements channel the fluid particles into long, thin and parallel flow paths along the element length, removing turbulence from the flow and reducing the effects of fluctuations in temperature within the system. In order to achieve laminar flow the Reynolds number of the fluid must be maintained below a threshold of approximately 2000. The Reynolds number is defined as:

$$Re = \frac{v ρ D}{μ}$$

where ν=mean velocity of the fluid; ρ=density of the fluid; D=diameter of the elements; and μ=viscosity of the fluid.

If the Reynolds number exceeds ˜2000, the fluid flow transitions back into turbulent flow, with increasing effect as the Reynolds number increases. This creates inaccuracies in the flow measurements, which in turn produces inaccuracies in the measurements of the remnant free volume of the annulus.

Before fluid is flowed through the gas line 107 from the source cylinder 102 into the annulus of the riser 150, initial pressures in the source cylinder 102 and riser 150 are optionally recorded in order to record a baseline pressure value. Optionally the regulated pressure is set and recorded. In the present example, a leak check on the whole test spread is optionally conducted to ensure that no fluid can escape to atmosphere during the test. In this example, we also optionally allow residual pressure from the annulus 150 to build up on gauge 110d, by opening valves 120r while valve 120d (after the laminar flow meter 105) and atmospheric vent valve 130 remain closed. As the residual annulus pressure is building and registering on gauge 110d, the test spread from supply to valve 120d after the laminar flow meter 105, which at that time will be closed, can be pressurised up to a regulated 2-3 barg. Once residual annular pressure appears to be stable on gauge 110d it is recorded and the test can begin by opening valve 120d and monitoring the governor 104 and the laminar flow meter 105.

In a first example, using the general method of annulus testing, nitrogen gas cylinder 102 is opened to release nitrogen gas into the gas line 107. The gas optionally flows through a two stage regulator 140, which comprises at least one digital gauge 110a, preferably two digital gauges 110a, 110b, which optionally measure the gas pressure in the regulator 140 in barg with different scales of measurement; for example one gauge 110a can measure a range of 0-300 barg while the other gauge 110b may measure 0-30 barg. Other ranges can be adopted if desired. The high pressure gauge 110a can optionally measure the pressure in the nitrogen gas cylinder 102, while the low pressure gauge 110b measures the test pressure. The nitrogen gas flows through the gas line 107 past at least one isolation valve 120, before reaching a pressure relief valve 103.

The pressure relief valve (PRV) 103 is used to protect the integrity of the riser 150 and to allow gas to vent from the system if the gas pressure in the line 107 exceeds a threshold. The PRV 103 is typically set at a higher pressure above other reliefs in the system but below the maximum risk threshold of the riser outer sheath 150 and the other components coupled to it. This maintains another level of control over the pressure contained within the system.

Optionally the system also has a means for measuring ambient temperature, such as combined pressure and temperature gauges connected in line with the gas line 107. Optionally the gauges can record the data. In this example, the gauges can be Leo recording gauges which digitally measure pressure and ambient temperature data and store it, allowing it to be downloaded post test to plot trends.

The gas optionally flows through at least one further pressure gauge 110c (which can optionally be adapted to sense pressure in the narrower range 0-30 barg). This gauge is used to regulate the pressure down from bottle supply pressure to system feed pressure, typically 3 barg, before the fluid flows through at least one further isolation valve 120c. The flow rate of the gas in the gas line 107 is then optionally governed by a flow rate limiting device 104, which in this example can comprise a float type rotameter 104 that acts to govern or restrict or otherwise control the flow of the fluid in the line, optionally before it passes into the laminar flow meter 105. Alternatively the flow rate may be governed or restricted or otherwise controlled by one of the valves, which could, for example, comprise a needle valve. By adding the extra step of flow governance, the pressure and velocity of the fluid passing into the laminar flow meter can be controlled. This maintains the fluid flow within the tolerances of the meter and assists in reducing the Reynolds number. Use of the rotameter additionally provides a visual indicator of the flow between the source cylinder 102 and the annulus 150. With high flow rates through the gas line 107, the float of the rotameter should be observed to start at the bottom of the rotameter glass, then progressively rising in the glass as flow increases. Observation of the float at the top of the glass indicates little or no restrictions between the supply and the annulus, whereas falling of the float from the top of the glass indicates a restriction. In this example, the system can achieve 2-3 barg pressure in the annulus and if there are no restrictions in the gas line 107, the float should start at top of the glass and as gas flows through the kit into the annulus the float should progressively fall as the pressure builds in the annulus and the back pressure in the gas line 107 reduces the flow until the whole system equalises.

The rotameter 104 optionally restricts the flow to a value within the range of 0-50 litres per minute; in this example, the flow rate is initially at 30 litres per minute. The restriction of the flow rate to within a narrow range of flow rates can help to optimise the flow of the gas into the laminar flow meter, and can allow more accurate readings.

The rotameter 104 governs the rate of flow into the laminar flow meter 105, which calculates the mass of nitrogen passing a particular point within the device per unit time. As the gas is undergoing laminar flow through the meter, it is possible to use Poiseuille's Law to determine the mass and volume of gas flowing through the tube.

Alternatively the volumetric flow rate may be directly measured, that is, the volume of gas passing a particular point within the device per unit time. The laminar flow meter 105 can be used in conjunction with an accumulated totaliser function on the meter 105 that converts the volumetric measurement into a measurement in terms of total litres. The total litres injected, along with the annular pressure, is useful information during the testing of the outer sheath integrity. The accumulated totaliser can be an integrated function or component of the laminar flow meter 105, or it can be a separate device.

Once the nitrogen flows through the laminar flow meter 105, it enters the annulus of the riser 150 through at least one valve 120r connected to the riser 150. In this example three valves 120r are connected to the riser annulus ports. The nitrogen is fed into the riser annulus, optionally until the pressure equalises between the internal pressure of the gas line 107 and the annulus of the riser 150. Alternatively, the test ends when the theoretical free volume of the annulus is exceeded; if the theoretical volume is exceeded without achieving an equilibrium from regulated pressure (2-3 barg) to a stabilised annular pressure (2-3 barg), this indicates a hole in the splash zone area from 0 to −20 m at 2 barg or −30 m at 3 barg. In the event of a splash zone breach, annular pressure would always return to the hydrostatic pressure value regardless of the volume of gas flowed in. The return to hydrostatic pressure offers conclusive evidence of a splash zone breach in the riser.

The theoretical free volume of the annulus of the riser 150 is known from manufacturing specifications, and can be confirmed in a factory acceptance test for the riser 150 and therefore this can be compared to the quantity of gas that is known to have been flowed into the annulus 150 by the testing kit 101. The theoretical free volume can be divided by the length of the flexible, and offers a litres per meter measurement. This in turn can be used to detect the level of fluid based on the achieved volume of gas to bring the system to an equalised 3 barg divided by 3. The difference between the theoretical free volume and actual measured free volume is compared to assess the condition of the riser, for example, to determine whether there has been a breach in the annulus, and if so, at which level of the riser 150.

The flow rate of injected gas will reduce in an annulus with good integrity as the internal pressure builds up, as the gas supply pressure is regulated at 2-3 barg. The integrity of the riser can be determined from the total number of litres of gas used to achieve a constant 2-3 barg pressure within the annulus. This value is then compared to the theoretical free volume, and litres per meter volumes. If a high number of litres (close to the corresponding theoretical free volume value) are required to achieve a constant 3 barg stabilised pressure, this indicates that the integrity of the riser is sound. If a constant 3 barg pressure is achieved with significantly fewer litres of gas than the theoretical values, this is indicative of a subsea breach in the outer sheath of the riser. If the value is lower than the theoretical free volume, but not critically so, this indicates acceptable outer sheath integrity with condensation accumulating within the annulus. The presence of condensate is indicated by the cessation of transfer of injected gas as a constant annular pressure is achieved. This is in contrast to the above-described return to hydrostatic pressure found in risers with splash zone breaches. This difference is very important when analysing the potential for corrosion of the riser due to sea water, in comparison to the less damaging presence of condensate.

For an annulus with a theoretical free volume of 1000 litres, some possible outcomes of the testing are illustrated by the following examples:

### EXAMPLE 1

In a first example, nitrogen gas fluid was flowed into the annulus of the riser 150 as described above, at a pressure of 3 barg, at an initial flow rate of 30 litres/minute and temperature of 25° C. for a period of time until the complete system equalises at 3 barg. It is useful to pressurise the annulus and generally the pressure in the annulus during testing with be somewhere between 1-3 barg. For example, although 3 barg is indicated in this example, the pressure peak in the annulus could frequently be about 2 barg. In a riser with good integrity the flow rate would ideally not be a constant and would progressively decay as the annular pressure built until an equilibrium was achieved at around 2-3 barg regulated pressure from supply and 2-3 barg or same value achieved in annulus and flow reduced to near zero levels. In the current example, the laminar flow meter measured 1000 litres of nitrogen flowed into the annulus. Thus the residual volume of the annulus according to the first example is 1000 litres. In this example, the actual volume determined by a test run on a first riser 150 is 1000 litres which conforms to the original pre calculated theoretical free volume of the flexible risers annulus. This indicates a full free volume within the annulus 150 at a level 151, well below the level of the surrounding seawater. The test therefore confirms that the integrity of the outer sheath is acceptable. Frequently, even if the riser integrity is acceptable, a low level of fluid within the annulus is found. This is indicative of condensation diffusing into the annular space from the inner liner 8. Condensation is a relatively common occurrence in the annulus of a riser 150, and it is useful to monitor the level of condensate within the annulus along with the composition. It is possible for gases such as carbon dioxide and/or hydrogen sulphide to permeate through the same layer and form an acidic solution with the condensate. Generally the condensate accumulates at the low points of any bends in the flexible pipe. Excessive accumulation of the condensate in the annulus of the riser 150 according to this example might indicate low level intervention. One possible example of low level intervention that would be suitable in the event that the low level of fluid found could be either seawater or condensate could be monitoring the annulus at repeated intervals, for example, daily, weekly, monthly or annually, depending on the severity of the fluid accumulation, optionally with a permeation rate and condensation calculation carried out. However, more usually, the presence and effects of condensation is accounted for in the design of the riser system. For example, if high levels of condensation are expected different grades of metal can be used in the manufacture of the tensile armour and intervention is generally not required.

### EXAMPLE 2

In a second example, the riser is treated according to the same procedure as above, flowing nitrogen gas into the riser 150 through the mass flow meter 105 at a pressure of 3 barg, a flow rate of initially 30 litres/minute and temperature of 25° C. for a period of time until the complete system equalises at 3 barg. In this example, it was found that the residual volume of the annulus of the riser 150 was approximately 500 litres. This indicates a fluid level within the annulus at a depth below sea level within the water column 152, and suggests a build up of condensate diffusion, as the identified fluid has not free flooded to sea level. Condensate is a naturally occurring phenomenon, which is generated through the normal operation of flexible pipelines carrying bore fluids of a certain composition

Seawater ingress into the riser system could be an alternative explanation for this fluid level in the riser annulus. If the fluid below sea level is not condensate then this would tend to indicate that the riser system is in the process of flooding, for example through a breach at the sea bed. In this situation, accurate volumetric trending would be recommended.

Sea water ingress through a breach in the outer sheath, and its associated effect on the pipeline structures, is assessed on a case-by-case basis, with analytical corrosion and fatigue studies carried out. The main factors for these studies are: the location of the breach within the water column; the environmental water temperatures in that region; the working pressures and temperatures of the pipeline system; the dynamic movements of the sea water; and the levels of oxygenation of the sea water. In a worst case scenario this could lead to a serious corrosion event that could require the urgent shut down, removal, and repair or replacement of the riser system due to a high risk of corrosion and fatigue in the layers of the flexible pipe, particularly the tensile armour 4, 4′ and the pressure armour 3. It is again possible for carbon dioxide and/or hydrogen sulphide to mix with the seawater and potentially exacerbate the corrosive effects of the seawater on the armour. The conditions found in example might indicate a more in-depth inspection campaign than the previous example, possibly including further investigations to confirm the possible indication of an external sheath breath below the water line. The information found would play a major part in the corrosion analysis conducted as a desk top study. Benchmark monitoring could be carried out at regular intervals over a period of 2-3 years in order to determine the rate of flooding and how rapidly intervention may be required.

### EXAMPLE 3

In a third example, the riser is treated according to the same procedure as above, flowing nitrogen gas into the riser 150 through the laminar flow meter 105 at a pressure of 3 barg, flow rate initially 30 litres/minute and temperature of 25° C. for a period of time until the complete system equalises at 3 barg. In this example, it was found that the residual volume of the annulus of the riser 150 was 150 l which is equivalent to the volume of the annulus between the top of the riser 150 and sea level. This indicates fluid at the air-water interface at sea level, for example to fluid level 153. This fluid could be seawater entering at the splash zone or below the water line and flooding the annulus up to the water line. In both of these cases the annulus is at severe risk of corrosion to the armour layers and other parts of the riser structure. Seawater entering the riser from the water line reintroduces oxygen into the metallic dynamic riser structure and creates a corrosion cell, which is constantly fed with seawater which is extremely corrosive because the splash zone contains high levels of dissolved oxygen as it is close to the air-water interface and is highly agitated by waves at the surface. The seawater increases the corrosive effects, and therefore increases the corresponding risk of failure. The fluid can equally be present from a subsea breach at a depth greater than −30 meters (splash zone)), which also has a corrosive effect. The conditions found in this example, after corrosion and/or life assessment, may necessitate the urgent shut down and removal of the riser system for repair or replacement, due to the high risk of pipe failure. It is also a region where the riser is cycling through wet and dry periods as the seawater splashes against it, contributing to the corrosive action of the water.

The annulus of the riser 150 can optionally be tested on more than one occasion, for example in sequential tests performed repeatedly and spaced apart by e.g. a month or a week, depending on the severity of the findings of the previous assessment, and the residual volume compared. Sequential tests can be repeated over a testing period of months or years, or on a continuous basis. Should the volume be shown to have stayed relatively close to the theoretical free volume, this tends to indicate that the annulus is at a low risk of requiring immediate and aggressive intervention. A decrease in the residual volume indicates rising fluid levels and a more urgent problem within the pipe, potentially requiring remedial action, and/or more frequent monitoring.

The nitrogen gas may be replaced with any similarly inert gas.

Some options for addressing breaches in risers include treating with corrosion inhibitor, removing and repairing damaged sections of the outer sheath, repairing damaged sections of the flexible pipe, or replacing components. Fatigue assessment is necessary as even when the outer sheath has been repaired, there may be sufficient damage to the pipe to significantly reduce the service life.

### EXAMPLE 4

In another example, the riser is treated according to the same procedure as above, flowing nitrogen gas under pressure into the riser 150 through the laminar flow meter 105 at a pressure of 3 barg, at an initial flow rate 30 litres/minute and temperature of 25° C. The annulus of the riser 150 may be filled until the pressure between the annulus testing kit 101 and the annulus itself equalises. Optionally at that stage, the valves are shut off, and the high pressure is held in the annulus, while the source of pressurised fluid is disconnected, after which the valves are opened to permit the high pressure fluid in the annulus to flow out of the fluid line, through the laminar flow meter 105, which verifies the quantity of gas flowing out of the annulus. This allows comparison between the inflow of the gas into the annulus and the outflow of gas out of the same annulus, which permits more accurate assessment of the quantity of gas and therefore the free volume of the annulus.

The calculated volume from the measured quantity of gas is then compared to the known theoretical volume. The magnitude of the difference between these two values indicates whether the annulus is subject to condensation or seawater ingress as described in examples 1-4 above.

This method can be repeated as often as required to monitor any changes in the residual volume of the riser annulus, and determine whether the fluid level is changing, and how rapidly.

Optionally in any of the above examples, the laminar flow meter can be moved from the gas inlet side of the apparatus and connected to an exhaust port to measure the volume of gas that is vented at the end of testing. The two values (input and exhaust) can then be compared for cross-checking. Due to gas permeation from the bore into the annulus, it is relatively common for the volume of vented gas to be slightly higher than the volume injected, within a range of 0-5% of the total injected volume.

Optionally a laminar flow meter can be connected at both the gas supply side and the exhaust port to measure the values without the need for reconnection. Alternatively, a laminar flow meter can be used independently at either side.

1. A method of assessing the condition of a tubular member, the method comprising flowing a fluid through a laminar flow device into the tubular member, wherein the laminar flow device is disposed in line with a fluid conduit delivering the fluid to the tubular member, into an annulus in the tubular member, wherein the tubular member comprises an outer and inner layer adapted to seal the annulus; and determining the remnant free volume of the annulus of the tubular member by measuring the volumetric flow rate of fluid through the laminar flow device and thus determining the volume of fluid injected into the tubular member.

2-10. (canceled)

11. The method as claimed in claim 1, including determining the remnant free volume of the annulus of the tubular member by determining the mass flow rate of fluid through the laminar flow device and thus determining and optionally recording the mass of fluid injected into the tubular member.

12. The method as claimed in claim 1, including measuring the temperature of the fluid flowing into the tubular member using at least one temperature sensor.

13. The method as claimed in claim 1, including measuring the pressure of the fluid flowing into the tubular member using at least one pressure sensor.

14-24. (canceled)

25. The method as claimed claim 1, including measuring the volume of fluid vented from the annulus of the tubular member and comparing the volume of fluid vented from the annulus of the tubular member with the volume admitted into the annulus of the tubular member.

26. The method as claimed claim 1, including calculating the mass of fluid injected into the annulus of the tubular member and the mass of fluid vented from the annulus of the tubular member and comparing the two values.

27. (canceled)

28. An apparatus for assessing the condition of a tubular member, the apparatus comprising a fluid conduit adapted to supply fluid from a fluid source to a tubular member, and a laminar flow device adapted to determine the volumetric flow rate of the fluid as it flows into the tubular member, wherein the laminar flow device is disposed in line with a fluid conduit delivering the fluid to the tubular member, into an annulus in the tubular member, wherein the tubular member comprises an outer and inner layer adapted to seal the annulus; and wherein the laminar flow device is adapted to determine the remnant free volume of the annulus of the tubular member by measuring the volumetric flow rate of fluid through the laminar flow device and thus determine the volume of fluid injected into the tubular member.

29-30. (canceled)

31. The apparatus as claimed in claim 28, including a flow rate limiting device comprising a rotameter.

32. The apparatus as claimed in claim 31, wherein the rotameter is configured to detect back pressure in the fluid conduit.

33-35. (canceled)

36. The apparatus as claimed in claim 28, wherein the laminar flow device comprises a mass flow meter.

37. (canceled)

38. The apparatus as claimed in claim 28, wherein a laminar flow device is placed on both the inlet and exhaust conduits to calculate the volume of fluid injected into the annulus of the tubular member, and the volume of fluid vented from the annulus of the tubular member.

39. The apparatus as claimed in claim 28, wherein the laminar flow device comprises a pressure sensor adapted to measure the pressure of the fluid flowing into the tubular member.

40-43. (canceled)

44. The apparatus as claimed in claim 28, wherein the tubular member comprises a riser system.

45. The apparatus as claimed in claim 28, wherein the tubular member comprises a flexible pipe.

46. The apparatus as claimed in claim 28, wherein the tubular member is adapted to provide a conduit through the water column between a subsea facility and a surface facility.

47. The apparatus as claimed in claim 28, wherein the tubular member is adapted for use with an offshore oil and gas well.

48-50. (canceled)

51. The method as claimed claim 1, including equalising the pressure between the fluid conduit and the tubular member.

52. The method as claimed in claim 1, including flowing fluid from a pressurised fluid supply into the annulus until a substantially constant pressure in the annulus is achieved and the pressure in the annulus and the pressure in the pressurised fluid supply are at equilibrium.

53. The method as claimed in claim 1, including flowing the fluid into the annulus at a flow rate that reduces to or near zero as pressure is equalized between the annulus and the fluid flowing through the fluid conduit.

54. The method as claimed in claim 1, wherein the tubular member comprises a riser of an oil or gas well providing a conduit through a water column between a subsea facility and a surface facility, and having an annulus between , and wherein the method includes determining the remnant free volume of the annulus.

55. A method of assessing the condition of a riser of an oil or gas well, wherein the riser provides a conduit through a water column between a subsea facility and a surface facility, the method comprising flowing a fluid through a laminar flow device into the riser, wherein the laminar flow device is disposed in line with a fluid conduit delivering the fluid to the riser, into an annulus in the riser, wherein the riser comprises an outer and inner layer adapted to seal the annulus; and determining the remnant free volume of the annulus of the riser by measuring the volumetric flow rate of fluid through the laminar flow device and thus determining the volume of fluid injected into the riser, wherein the method includes flowing fluid from a pressurised fluid supply into the annulus until a substantially constant pressure in the annulus is achieved and the pressure in the annulus and the pressure in the pressurised fluid supply are substantially at equilibrium, and wherein the fluid is flowed into the annulus at a flow rate that approached zero as pressure is equalized between the annulus and the fluid flowing through the fluid conduit.
